(19) United States
(12) Patent Application Publication
(10) Pub. No.: US 2013/0216862 A1
(43) Pub. Date: Aug. 22, 2013

(54) Coating Compositions, Applications Thereof, and Methods of Forming

(71) Applicants: Justin Lee Cheney, San Francisco, CA (US); Grzegorz Jan Kusinski, Moraga, CA (US)

(72) Inventors: Justin Lee Cheney, San Francisco, CA (US); Grzegorz Jan Kusinski, Moraga, CA (US)

(73) Assignee: c/o Chevron Corporation, San Ramon, CA (US)

(21) Appl. No.: 13/402,289

(22) Filed: Feb. 22, 2012

(51) Int. Cl. B32B 15/01; B05D 1/08

(52) U.S. Cl. 428/656; 427/449

(57) ABSTRACT

Equipment (work piece) for use in corrosive resistant coating on equipment is disclosed. The equipment has at least a portion of its surface coated with a layer formed from a NiCrMo alloy composition containing at least two gettering components selected from Al, Si, and Ti in an amount of up to 25 wt. %. The coating in one embodiment is applied on the equipment using a thermal spray technique, e.g., twin wire arc spray, forming coatings of 5-50 mils thickness having a fine-scale micro-pore structure. The coating layer is characterized as having excellent adhesion strength and corrosion resistant properties, even when applied with varying parameters as in manual on-site coating applications. In one embodiment, the coating layer has an impurity content of less than 15%.

### TECHNICAL FIELD

The invention relates generally to a corrosion resistant coating, equipment employing the coating, and method to form the coating.

### BACKGROUND

Corrosion is a known problem in a number of industries. In the oil and gas industry (O&G) alone, corrosion costs US refineries over $4 billion annually. Periodically depositing a corrosion resistant surface onto existing equipment is generally an economical method for protecting metallic components in aggressive environments, e.g., corrosive environments containing strong acids such as sulfuric acid, or bases at elevated temperatures. The coating is typically deposited using a thermal spray process. The technique is commonly used to protect refinery vessels, power generation equipment, chemical processing baths, and other large scale industrial surfaces.

In coatings made by a thermal spray process such as twin wire arc spray (TWAS), elemental components particularly the powdered species of the cored wire can oxidize (“in-flight particle oxidation”). Oxidation of the atomized molten thermal spray material is undesirable for several reasons, including: a) selective oxidation of alloying elements such as chromium, which reduces the corrosion performance of the deposited coating; b) the oxides embedded within the coating are not effective at sealing porosity in service; and c) high oxide content generally decreases both the adhesion of the coating to the substrate and the inter-particle adhesion. TWAS coatings generally contain a high degree of porosity in the range of 5%-10%, and oxide content in the range of 5-10%. Such a high level of porosity inevitably leads to what is termed “through-porosity” or “inter-connected porosity,” meaning the coating is permeable to corrosive media leading to corrosion attacks regardless of the inherent corrosion performance of the thermal spray coating alloy. Additionally, corrosive media trapped in small pores can result in aggressive localized attack. As such, it is desirable to reduce the oxide content in thermal spray coatings.

There are a number of references disclosing thermal spray coating compositions. U.S. Pat. No. 4,561,892 discloses the use of a powder alloy of specific composition used in the plasma thermal spray process to deposit a corrosion resistant coating. U.S. Pat. No. 5,120,614 discloses a Ni—Cr-refractory type alloy to resist high temperature oxidation and acid attack suitable for use as bulk or weld overlay materials. U.S. Pat. No. 4,027,367 discloses nickel-aluminum alloy compositions for arc spray applications, forming a self-bonding coating. U.S. Pat. Nos. 4,453,976; 4,529,616, and 5,326,645 disclose powder alloys for use in thermal spray and flame spray applications. U.S. Pat. Nos. 2,875,042 and 7,157,151 disclose compositions for use in spray and fuse technique to form coatings.

There is still a need for coatings with improved characteristics in as-sprayed condition. There is also a need for improved methods to apply coatings, particularly for coating large surface areas on-site. The invention relates to improved compositions for thermal spray techniques, providing coatings with low porosity/oxide content.

### SUMMARY

In one aspect, the invention relates to a method for forming a protective coating on an equipment for use in a corrosive environment. The method comprises: preparing a substrate on the equipment to be coated; applying a coating layer comprising a NiCrMoX alloy onto the substrate to be coated, X contains at least two gettering elements selected from Al, Si, Ti in an amount of 5-20 wt. %; wherein the coating layer formed by the alloy has an impurity content of less than 15%, a corrosion rate of less than 150 mpy measured according to ASTM G31, and an adhesion strength of at least 9,000 psi measured according to ASTM D4541. In one embodiment, the coating is applied by thermal spraying a cored wire formed with a sheet having an alloy composition of NiCrMo rolled into a tubular form rolled into a tubular form containing X as a powder contained within the tubular form as the core, wherein X contains Al and Si as gettering elements, and wherein the gettering elements have at least a 30% decrease in deposition efficiency for Al and at least a 20% decrease in deposition efficiency for Si.

In another aspect, the method comprises: preparing a substrate on the equipment to be coated; applying onto a substrate a coating layer using thermal spray coating with a wire feedstock comprising a nickel alloy composition containing in weight %: Cr: 12%-25%; Mo: 8%-15%; and at least two gettering elements selected from Al: 0.25-12%, Si: up to 10%, and Ti: up to 5%; balance of Ni and unavoidable impurities; wherein the coating layer formed by the nickel alloy composition has an impurity content of less than 15% , a corrosion rate of less than 150 mpy measured according to ASTM G31, and an adhesion strength of at least 9,000 psi measured according to ASTM D4541.

In yet another aspect, the invention relates to a method for forming a protective coating on an equipment for use in a corrosive environment. The method comprises: applying onto at least a surface on the equipment a coating layer using thermal spray coating with a wire feedstock having components of NiCrMoX, wherein the Ni—Cr—Mo components form an alloy sheath rolled into a tubular form, wherein the X component contains Al and at least one of two gettering elements Si and Ti and forms a powder contained within the tubular form as the core, wherein the powder is in an amount of 5-20 wt. % based on total weight of the wire feedstock; wherein at least 10% of the gettering elements form hard oxide particles which do not adhere to the surface of the equipment and function to grit blast the surface for the coating layer formed to have an adhesion strength of at least 9,000 psi measured according to ASTM D4541. In one embodiment,the method is for periodic coating of equipment selected from the group of recovery boilers, furnace tubes, metal sheets, panels, pressure vessels, separator vessels, drums, rail cars, heat exchangers, pipes, heat exchanger parts, storage tanks, valves, chamber enclosure wall, substrate support, gas delivery system and components, and gas exhaust system and components.

In one aspect, the invention relates to a work piece having a protective coating on at least a surface. The work piece comprises: a metal surface onto which a coating is applied by thermal spraying a wire comprising a NiCrMoX alloy, wherein X contains at least two gettering elements selected from Al, Si, Ti in an amount of 5-20 wt. %; wherein the coating has as an impurity content of less than 15%, a corrosion rate of less than 150 mpy measured according to ASTM G31, and an adhesion strength of at least 9,000 psi measured according to ASTM D4541.

In yet another aspect, the work piece comprises: a metal surface onto which a coating is applied by thermal spraying a wire feedstock comprising a nickel alloy in weight %: Cr: 12%-25%; Mo: 8%-15%; and at least two gettering elements selected from Al: 0.25-12%, Si: up to 10%, and Ti: up to 5%; balance of Ni and unavoidable impurities; wherein the coating has an impurity content of less than 15% , a corrosion rate of less than 150 mpy measured according to ASTM G31, and an adhesion strength of at least 9,000 psi measured according to ASTM D4541. In one embodiment, the coating is applied to repair at least a portion of the metal surface on the work piece.

### BRIEF DESCRIPTION OF THE DRAWING

FIG. 1 is a diagram showing the self-grit blasting effect in one TWAS embodiment.

FIG. 2A is a diagram showing an embodiment of TWAS coating using a metallic wire feedstock, forming grit blasting particles.

FIG. 2B is a diagram showing an embodiment of TWAS coating using a wire feedstock, forming grit blasting particles.

FIG. 3 is a scanning electron micrograph (SEM) comparing two thermal spray coatings samples, one coated with the prior art Alloy C276 and one coated with an embodiment of the inventive coating.

FIG. 4 is a graph comparing coating adhesion of the prior art Alloy C276 and an embodiment of the invention under a variety of spray distances and traverse rates.

FIG. 5 contains micrographs at 100×, comparing 25-30 mil thermal spray coatings of the prior art Alloy C276 and an embodiment of the invention, sprayed via similar parameters using TWAS.

FIG. 6 compare the microstructures of the prior art Alloy C276 coating vs. an embodiment of the invention, using image analysis software to show impurity content.

FIG. 7 is a micrograph from an energy dispersive spectroscopy (EDS) study showing the selective elemental oxide formation in an embodiment of the invention.

FIG. 8 is a graph comparing the alloy content in oxide and metal species within thermal spray coating structure of the coating embodiment in FIG. 7.

FIG. 9 is a graph comparing the wire feedstock chemistry and chemistry of metallic phase within a coating embodiment of the invention.

### DESCRIPTION

The following terms will be used throughout the specification and will have the following meanings unless otherwise indicated.

A “layer” is a thickness of a material that may serve a functional purpose including but not limited to erosion resistance, reduced coefficient of friction, high stiffness, or mechanical support for overlying layers or protection of underlying layers.

“Coating” is comprised of one or more adjacent layers and any included interfaces. Coating also refers to a layer is placed directly on the substrate of the article to be protected. In another embodiment, “coating” refers to the top protective layer.

“Substrate” refers to a portion or the entire surface an article, e.g., a work piece, equipment or portions of an equipment to be protected by a coating of the embodiment. The article to be coated can be of any shape, e.g., tools, the interior of a structural component such as a pipe, a vessel, or a tank.

“Non-ideal conditions” in the context of thermal spraying refers to spraying on-site by hand over large surface areas and deviating from optimal spraying conditions (e.g., consistent traverse rate, consistent coating thickness, exact spray distance and perfect 90° angle to the substrate), as it is not possible for a human operator to steadily hold a 15 lb. gun and maintain exacting coating parameters for eight hours while traversing thousands of square feet.

“Impurity content” is defined as the sum of the porosity and oxide content volume fraction in a coating.

“Gettering elements” refer to metals such as aluminium, titanium, and silicon that react preferentially with the oxygen and nitrogen in the steel.

In one embodiment, the invention relates to compositions that form high bond strength low permeability coatings for corrosion protection, and methods for depositing such coatings including thermal spray processes such as high velocity continuous combustion, plasma spray, flame spray, high velocity oxyfuel, arc jet, arc spray, and twin wire arc spray (TWAS).

Alloy Compositions: The alloy composition is a Ni—Cr alloy or a Ni—Cr—Mo alloy, capable of forming an austenitic nickel coating. In one embodiment, the alloy composition has at least 75% volume fraction in the form of austenitic nickel phase structure. The composition in the form of NiCrMoX or NiCrX, with a sufficient amount of oxide gettering elements X to prevent the oxide attack of corrosion resistant alloying elements such as chromium or molybdenum, and reduce overall embedded oxide content. Furthermore, the composition is controlled such that the alloy has a low melting temperature and behaves in a more fluid matter during deposition, resulting in a lower coating porosity and higher adhesion. X contains at least two of Al, Si, and Ti. In one embodiment, the alloy composition is in the form or a cored wire formed via a Ni—Cr alloy filled with a blend of powder alloy to produce the desired Al, Si, and Ti content, which is formed as a sheath rolled in a tubular form with powder alloy components within (“cored wire”). For some applications to produce high bond strength low permeability corrosion resistant coatings, the composition can be employed as a powder feedstock or solid wire.

In one embodiment, the alloy has a composition in weight %: 12-25% Cr; 8-15% Mo; two or more gettering elements selected from Al, Si, and Ti in an amount of up to 12% each with a total concentration of 5-25%; balance of Ni and unavoidable impurities. In one embodiment, the total concentration of gettering elements is between 5-20% with each component concentration of less than 10%. In another embodiment, the total concentration of gettering elements is between 5-10% with each component concentration of less than 7%.

In another embodiment, the alloy has the composition of: Ni: balance; Al: up to 12%, Cr: 12%-25%, Mo: 8%-15%, Si: up 10%, Ti: up to 5%. In one embodiment, the amount of Al and Si is at least 0.25% each. In yet another embodiment, the alloy has a composition of any of:

Alloy 1: Ni: bal, Al: 1.85, Cr: 20.0, Mo: 10.4, Si: 6.21, Ti: 0.16;

Alloy 2: Ni: bal, Al: 2.73, Cr: 20.4, Mo: 8.64, Si: 4.83, Ti: 0.67;

Alloy 3: Ni: bal, Al: 1.5, Cr: 20.0, Mo: 12.7, Si: 5.98, Ti: 0.15; and

Alloy 4: Ni: bal, Al: 3, Cr: 20.0, Mo: 12.7, Si: 5.98, Ti: 1.0.

The inventive alloy composition is designed using computational metallurgical techniques for an alloy having a high chromium (e.g., ˜>20%), high molybdenum (e.g., ˜>10%) concentration for a reduced liquidus temperature (<1500° K. or <1227° C., or <2240° F.). Additional considerations include but are not limited to an inherent exothermic reaction, which occurs when the cored wire components are alloyed together and with the addition of nickel and aluminum. This reaction increases the overall heat input into the system, for a high energy splat which more effectively bonds the coating to the substrate.

Additional design criteria include the selective formation of hard particles during the spray process, with controlled amounts of oxide gettering elements such as aluminum, silicon, and titanium. The selected components have the effect of preferentially forming high temperature oxides (“grit blasting components”) and low electronegativity values (lower than the base metal and other desired deposition elements) on the Pauling scale, which is ideal in creating a grit blasting effect. The oxide particles with high melting temperatures tend not to attach the coating during spray, but affect the metallic species of the existing coating through plastic deformation for increased adhesion strength.

Examples of the grit blasting particles in thermal sprayed coatings include but are not limited to oxides, nitrides, carbo-nitrides, carbides and complexes thereof of Al, Ti, Si, including but not limited to silicon aluminum oxide, titanium silicon oxide, etc. (collectively referred to as “hard oxide particles”). Chromium oxide does make an effective grit blasting component. However, the formation of chromium oxide is generally undesirable due to the depletion of chromium in the metallic component of the coating, which will typically decrease corrosion performance. While some of the hard oxide particles do become embedded in the coating, a portion simply bounce off the coating surface after the initial contact, for a thermal sprayed coating with at least 10% less oxide gettering elements in metal or metal oxide form as compared to the original concentration of the gettering elements in the wire feedstock. In a second embodiment, the coating has at least 20% less Al (as metal or aluminum oxide) as compared to the amount of Al originally in the wire feedstock. With the grit blasting effect of the hard oxides bouncing off and not attached to the surface, the particles cause additional plastic deformation in the metallic species of the coating, thereby roughening the surface, relieving thermal and tensile stresses, increasing bond strength, and decreasing porosity.

In the coating formed by the alloy composition of the invention, oxides of Al, Ti and Si preferentially form compared to oxides of Cr, Mo, and Ni, as indicated by the relatively high content of Al, Si, and Ti in the oxide chemistry of the coating compared to the low content in the feedstock wire. In one embodiment, the ratio of aluminum oxide to aluminum in the coating is at least 5:1. In another embodiment, the ratio is at least 10:1. On the other hand, the ratio of chromium oxide to chromium in one embodiment is at most 4:1 in one embodiment and 3:1 in a second embodiment.

In the form of a coating, the grit blasting particles in the alloy composition have average particle sizes ranging from 1 to 50 μm in one embodiment; 5 to 30 μm in a second embodiment; and 8 to 25 μm in a third embodiment. The grit blasting components have a concentration ranging from 5 to 25% of the total un-deposited material in one embodiment; 8 to 15% in a second embodiment; about 10% in a third embodiment; and from 20-25% in a fourth embodiment.

Due to the grit-blasting effect, the total deposition efficiency of the gettering elements such as aluminum, silicon, and titanium in coating applications is less than 70% in one embodiment; less than 60% in a second embodiment; and less than 50% in a third embodiment. Generally, prior art twin wire arc spray materials have 70% deposit efficiency. In one embodiment, the thermal spraying results in at least a 30% decrease in the deposition of metallic aluminum and at least a 20% decrease in the deposition efficiency of metallic silicon. Deposit efficiency is computed as the ratio of weight of materials deposited as coating to weight of feed materials.

In one embodiment in the form of a cast ingot, the alloy composition has multi-phase structure per examination of the microstructures via X-ray diffraction (XRD). The two-phase microstructure of the cast ingot, as measured via energy dispersive spectroscopy, shows hard molybdenum silicide particles in a nickel matrix depleted of molybdenum content. Such a microstructure is vulnerable to corrosive attack due the nickel matrix being depleted in molybdenum. In one embodiment in the form of a coating, the alloy composition has a single phase austenite structure. The elimination of the molybdenum silicide particles in the thermal spray coating is an indication that oxide forming elements such as Si and Al preferentially react with oxygen when travel from the spray gun to the substrate.

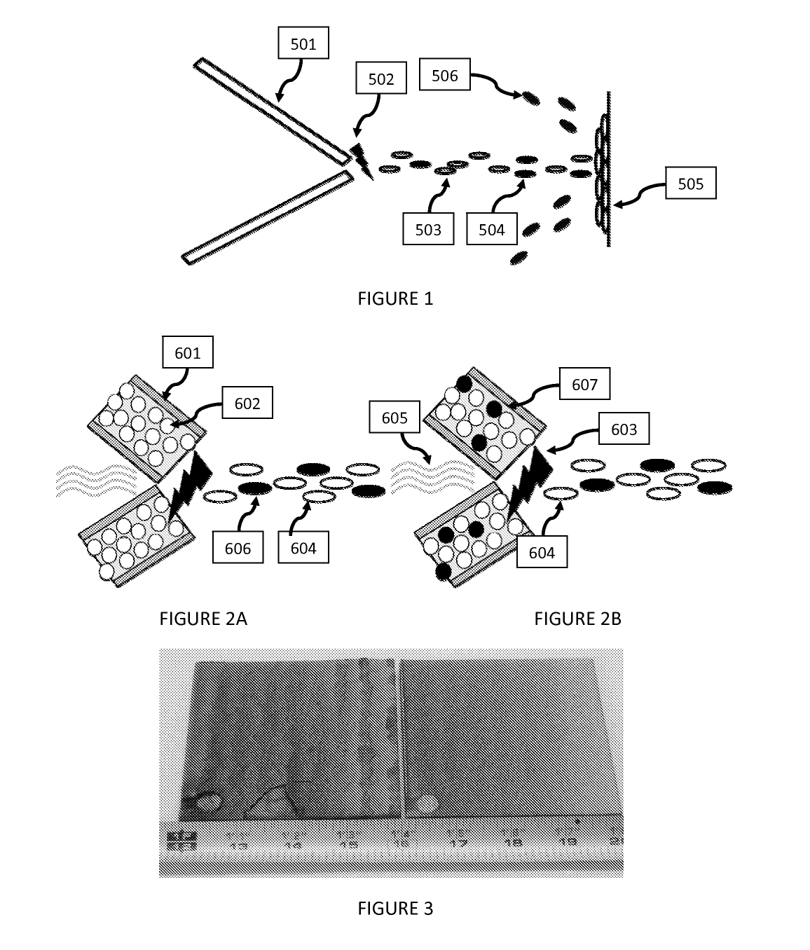

Reference will be made to the figures to further illustrate the grit blasting effect of the alloy compositions. FIG. 1 is a diagram showing twin wire arc spraying of an embodiment of the alloy composition with a self-grit blasting effect. The grit blasting components can be inserted into the wire during manufacture (as cored wire) or forms in suit during the spray process. In either case, the thermal spray feedstock material (501) passes through the arc (502) to form a thermal spray plume composed of metallic (503) and grit blasting components (504). As this spray plume impinges upon a substrate, the metallic particles will preferentially stick, resulting in a primarily metallic coating (505); the oxide grit blasting particles will preferentially bounce off the substrate as non-attaching grit blasting particles (506). Although a fraction of these oxides will become embedded into the coating, most will bounce off the substrate as grit blasting components. The non-attaching grit blasting particles beneficially affect the metallic coating by inducing plastic deformation, surface roughness, relieving stresses and collapsing pores. Thermal spray coatings are formed in this fashion are characterized as having higher adhesion, lower permeability, and reduced effective corrosion rates.

In one embodiment as illustrated in FIG. 2A, the grit blasting components are selectively formed as sprayed. As shown, metallic tubular wire (601) is carrying a blend of powder (602) void of any grit blasting components. As the cored wire travels through the arc (603), a portion of the powder (602) reacts with the environment and air stream used to propel the molten metal, forming a grit blasting particle or component (606) during the spray process. The metallic particles (604) are left free to form a denser, more adherent, more corrosion resistant coating.

In another embodiment as illustrated in FIG. 2B, the oxide gettering components (607) are inserted into the cored wire as a fraction of the total powder component, or as the entirety of the powder component of a cored wire (not shown). This is intended to be used when the grit blasting effect is to be maximized. As in the as-sprayed formation process, the metallic sheath (601) also contains metallic particles (602) which are heated across the arc (603) and propelled towards the coating surface as metallic droplets (604) via the atomizing gas (605). A certain portion of the atomized thermal spray particles become oxidized and either act as additional grit blasting components or become embedded in the coating (not shown).

Applications: The alloy composition, as cored wire, solid wire, or powder feedstock, is suitable for use in coating applications including but not limited to thermal spray or welding. In one embodiment, the composition is a cored wire formed via a Ni or Ni—Cr alloy, filled with a blend of powder alloy components used to produce the alloy content with Mo and gettering elements such as Al, Ti, and Si. In another embodiment, the composition is in the form of powder feedstock or solid wire in order for a high bond strength, low permeability corrosion resistant coatings.

The alloy composition can be applied in one application as a single layer, or as a plurality of layers forming a coating. The alloy composition is applied as coating layer on a substrate (equipment or work piece) with a thickness of at least 4 mils (0.10 mm) in one embodiment; from 10 to 50 mils in a second embodiment (0.254 mm-1.27 mm); and from 20 to 100 mils in a third embodiment (0.508 mm-2.54 mm)

The coating can be used in any new manufacturing and remanufacturing applications requiring a protective coating. The coating can also be used for sealing of a work piece (used interchangeably with “equipment”) as well as for wear and corrosion resistant applications on a work piece. In one embodiment, the composition is for coating equipment used in corrosive environments in energy, health and environmental, oil and gas, pharmaceutical and flue gas desulfurization. The composition is particularly suitable for coating equipment with frequent exposure to acetic, sulfuric, hydrochloric, hydrofluoric, and carbonic acids, molten sulfur, NaOH, H₂S, CO₂, ammonia, wet chloride gas, hypochlorite and chlorine dioxide solutions, e.g., pharmaceutical reaction vessels, process chambers, pressure vessels for use in the chemical industry and oil and gas industry such as refineries. The substrate of the work piece or the equipment to be coated can be a portion of the equipment exposed to the corrosive environment, or a portion of the equipment that has to be repaired/coated, or the coating can be applied to the entire surface of the equipment.

In one embodiment, the composition is for periodic coating and/or repairing equipment for use in harsh corrosive environments including but not limited to recovery boilers, furnace tubes, metal sheets, panels, pressure vessels, separator vessels, drums, rail cars, heat exchangers, pipes, heat exchanger parts, storage tanks, valves, chamber enclosure wall, substrate support, gas delivery system and components, gas exhaust system and components, etc.

In one embodiment, the alloy is for coating mechanical components for use in severe corrosion along with wear and erosion exposure such as downhole gas production. The coating can also be used to protect equipment from further corrosion, e.g., after general corrosion and the formation of pits on interior surface exposed to corrosive attacks. In one embodiment, the coating is used to repair the overlay in a pressure vessel after the cracks are ground out of the overlay for the coating to stay in place and protect the underlying base metal. In another embodiment, the coating is applied on packing areas of reformer stem valves, repairing liquid sulfur rail cars with localized attack. In yet another embodiment, the coating is applied onto heat-affected zones of head seam weld and impingement areas near process stream inlets in condenser heads.

The substrate of the equipment to be coated with the alloy composition can be constructed of iron, nickel, cobalt, or copper based alloy. In one embodiment, it is welded galvanized steel. In one embodiment prior to thermal spraying to form a coating, the substrate surface is given a cleaning to remove all diffusion barriers such as paint, coatings, dirt, debris, and hydrocarbons to a state known as white metal. In another embodiment, the surface is given an anchor profile abrasive blast ranging from 0.5 mils (0.0254 mm) to 6 mils (0.1524 mm) to provide initial anchor profile for the thermal sprayed coating to better mechanically bond to the substrate.

The coating can be applied on the substrate using any of conventionally sprayed combustion, arc, plasma, HVAF (high velocity air fuel), or HVOF (high velocity oxygen fuel) techniques. In one embodiment, the coating can be applied by hand (without gun motion control devices) or via an automatic gun, using any of high velocity continuous combustion, plasma spray, flame spray, high velocity oxyfuel, arc jet, arc spray, and twin wire arc spray.

In one embodiment, the coating is applied using the twin wire arc spraying (TWAS) process. In a TWAS process, a thermal sprayer comprises two consumable electrodes that are shaped and angled to allow an electric arc to form in an arcing zone there-between, as shown in FIG. 1. The consumable electrodes may comprise twin wires formed from the alloy composition, which wires are angled to allow an electric discharge to form. An electric arc discharge is generated between the electrodes when a voltage is applied to the electrodes while a carrier gas is flowed between the electrodes. Arcing between the electrodes atomizes and at least partially liquefies the metal on the electrodes and carrier gas energized by the arcing electrodes propels the molten particles out of the thermal sprayer and towards the substrate surface, where they cool and condense to form a coating.

In one embodiment of a TWAS process, the particles are subject to temperatures from 1650° C. to 2760° C. (3000° F. to 5000° F.), and then atomized and propelled towards the substrate via a high pressure (˜600 Pa or ˜90 psi) air stream. In another embodiment, the coating is formed with a spray gun having a power supply between 150-250 Amps and 25-35 Volts and varying thermal spray parameters including: spray distance of 5-10″; coating thickness of 0.5-60 mils; spray angle of 30-90°; traverse rate of 100-1000 inches/min; and thickness per pass ranging from 1-20 mils.

Properties: In one embodiment, the alloy composition forms a lower porosity coating with reduced or minimal permeability due to the low inherent melting temperature of the alloy, the exothermic reaction between Ni and Al, and the in-situ forming of hard oxide grit during spray. In one embodiment, the alloy composition forms a thermal sprayed coating characterized with an impurity content of less than 15%. In another embodiment, the coating has an impurity content of less than 12%. In a third embodiment, an impurity content of less than 10%. In one embodiment, the impurity content is measured in a coating thermal sprayed at a wide range of spray angles of 30 to 90° and coating thickness ranging from 15 mils to 60 mils. In yet another embodiment, the coating has an impurity content of less than 8% for coatings when thermal sprayed at an optimal 90° angle.

The low impurity content provides a coating with low permeability characteristics and inherently excellent corrosion resistant properties of less than 150 mpy (mils per year) corrosion rate in embodiment, measured according to ASTM G31. The corrosion test is conducted in 350° F. sulfuric acid at 83% concentration for two weeks. The corrosion rate is less than 125 mpy in a second embodiment, and less than 100 mpy in a third embodiment.

In one embodiment with the grit blasting effect, the alloy composition forms a thermal sprayed coating having adhesion strength of at least 7000 psi (48 MPa) measured according to any of ASTM D4541 and ASTM D7234. Adhesion strength herein refers to the average adhesion strength from different locations across the coating surface. In another embodiment, the adhesion strength ranges from 55-70 MPa (8,000-10,000 psi). In one embodiment, a thermal sprayed coating has an adhesion strength of at least 10,000 psi (48 MPa).

The thermal sprayed coating in one embodiment is further characterized as having a relatively constant adhesion strength, with an adhesion strength variation of less than 25% for spray angle variations of ±60° (from)90°. Spray angle variations are typically expected when there is a need to spray in a tight surface or when spraying uneven surfaces. 90° is the optimal condition when spraying flat surfaces. In one embodiment, the adhesion strength is at least 7000 psi (48 MPa) when sprayed at a spray angle of 30°-90°.

The coating is also characterized as having a relatively constant adhesive strength even with varying traverse rate and spray distance, with adhesion strength variations of less than 25% across the coating surface for traverse rate variations of ±600 inches/min. In one embodiment, the adhesion strength is at least 7000 psi (48 MPa) for a traverse spraying rate in the range of 100-200 inches/min.

The coating is further characterized as not impacted by spalling. It is known that the worst, although relatively common, form of failure for thermal spray coatings is the spalling of the mechanically bound coating from the substrate and leaving the substrate material entirely exposed. Spalling can occur for several reasons: impact, erosive stresses, thermal stress, and corrosive underpinning, among others. When not applied properly, the coating can immediately spall from the substrate during the spray process. With strong adhesion to the substrate, the high integrity coating formed with the alloy composition is expected to have much longer lifetime than coatings of the prior art even when spraying is done under non-ideal conditions.

Examples: The following illustrative examples are intended to be non-limiting.

In the examples, a solid wire with a prior art composition Hastalloy™ C276 composition and a cored wire (Alloy 1) were used with compositions as shown in wt. %.

C276: Ni (bal), Co (0-2.5), Mn (0.35), Si (0.01), Cr (14.5-16.5), Fe (4-7); Mo (15-17); W (3-4.5);

Alloy 1: Ni (bal), Al (1.85), Cr (20), Mo (10.4), Si (6.21), Ti (0.16).

The secondary alloying components in C276 (Co, W, Fe, W, Si, and Mn) have the effect on properties relevant to a bulk form such as ease of fabrication, microstructure of wrought forms, etc. In Alloy 1, the secondary alloying components in affect the spray-ability and performance of the material under the arc spray process, with elevated chromium content to account for the preferential in-flight oxidation of chromium during the spray process, and elevated silicon concentration to improve corrosion resistant properties. The as-deposited metallic component of the Alloy 1 coating is expected to closely resemble the chromium and molybdenum levels found in wrought alloy C276.

Coatings were deposited on substrates via robot using similar parameters, 200 amps, 32 volts, 85 psi gas pressure, green air cap, short cross positioned, TAFA spray gun, CP 302 power supply, 100″/min traverse rate, 5″ spray distance, 90° spray angle, and 20 mil coating thickness. FIG. 3 is a micrograph comparing the Alloy C276 coating with the Alloy 1 coating. As shown, spalling or danger of spalling is seen in the Alloy C276ing coating.

Additional thermal sprayed coatings were carried out via robot using robot (ideal conditions) and by hand (non-ideal conditions), using both the TWAS and HVAS (high velocity arc spray) techniques. Hand spraying was to simulate the non-ideal conditions.

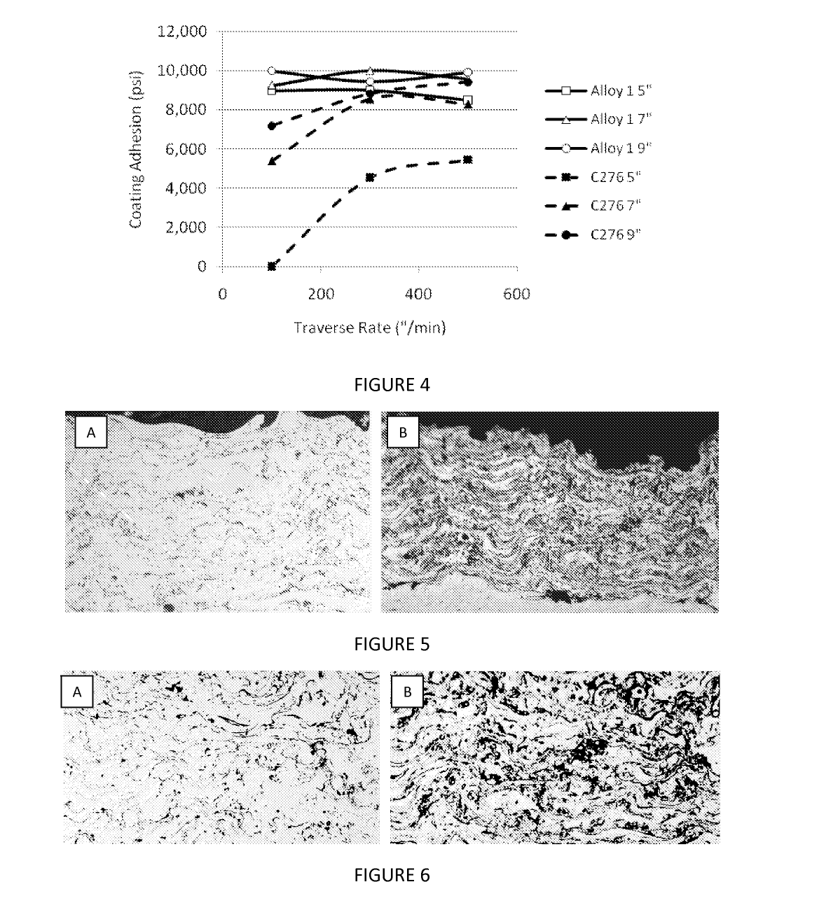

Adhesion Strength Tests: The results showed that Alloy 1 formed coatings with 8,000 to 10,000 psi bond strengths on a 3.5 mil profile surface in all test conditions, ideal or non-ideal, measured according to ASTM D4541/ASTM D7234. Alloy C276 formed coatings with greater than 8,000 psi adhesion strength coatings under ideal conditions, with a sharp drop-off in adhesion strength to 2,000 psi or less in some cases under non-ideal conditions. FIG. 4 compares the coating adhesion strengths of Alloy 276 and Alloyl under a variety of spray distances (5″, 7″, and 9″) and traverse rates (100″/min, 300″/min, and 500″/min)

In different tests at various coating thicknesses, Alloy 1 also shows consistent high adhesion strength results as sprayed at a variety of angles and coating thickness levels, with values being averaged from at least 3 adhesion tests:

TABLE 1

| Thickness | 30° angle | 45° angle | 90° angle |
|---|---|---|---|
| 0.015″ | 7,580 psi | 9,263 psi | 9,247 psi |
| 0.023″ | 7,931 psi | 6,659 psi | 7,373 psi |
| 0.060″ | 8,251 psi | 9,473 psi | 10,000* |

*indicates glue failure occured with no coating separation from substrate.

* indicates glue failure occurred with no coating separation from substrate.

Adhesion Variations Under Different Spraying Conditions: Additional tests were conducted to evaluate the coatings under different parameters, including ideals and non-ideal spray conditions. The ideal spray conditions include: 7″ spray distance, 700″/min traverse rate, and a 90° spray angle. Smaller (5″) and larger spray distances (9″) were used to study the parameter range an operator might oscillate between when hand spraying a vessel. Although 700″/min is determined to be an ideal rate, it is relatively fast for an applicator to hand spray large surface areas for a long period of time. Thus, slower traverse rates were included to simulate realistic conditions including the possibility of applicator fatigue. Spray angle parameters were varied from 90°, the optimal condition, to 30°, a non-optimal condition which can occur even when spraying flat surfaces, but will certainly occur when the need to spray in tight spaces arises. The results in Table 2 show that Alloy 1 coatings display consistent high adhesion strength results.

TABLE 2

| | Traverse | Spray | | Thickness | Surface | Adhesion | |
|---|---|---|---|---|---|---|---|
| Alloy | rate | distance | Angle | per pass | T ° F. | psi | Mode* |
| 1 | 100 | 5 | 90 | 10 | 290 | 8,976 | C |
| 1 | 300 | 5 | 90 | 10 | 200 | 9,000 | C |
| 1 | 500 | 5 | 90 | 5 | 150 | >8,500* | G, 15% C |
| 1 | 700 | 5 | 90 | 3 | 100 | 10,000 | A |
| 1 | 100 | 7 | 90 | 16 | 200 | 9,250 | C |
| 1 | 300 | 7 | 90 | 5 | 150 | >10,000* | G, 10% C |
| 1 | 500 | 7 | 90 | 4 | 150 | 9,588 | C, 10% G |
| 1 | 100 | 9 | 90 | 20 | 250 | >10,000* | G, 10% C |
| 1 | 300 | 9 | 90 | 7 | 150 | 9.458* | G, 10% C |
| 1 | 500 | 9 | 90 | 4.2 | 150 | 9,924 | C, 10% G |
| 1 | 300 | 7 | 30 | 6 | 150 | >10,000* | G |
| 1 | 500 | 7 | 30 | 4 | 150 | >10,000* | G |
| C276 | 100 | 5 | 90 | 10 | 400 | 0 | N/A |
| C276 | 300 | 5 | 90 | 6 | 375 | 4,540 | A |
| C276 | 500 | 5 | 90 | 5 | 350 | 5,460 | A |
| C276 | 700 | 5 | 90 | 3 | 250 | 6,100 | A |
| C276 | 100 | 7 | 90 | 16 | 230 | 5,392 | A |
| C276 | 300 | 7 | 90 | 6.5 | 230 | 7,928 | A |
| C276 | 500 | 7 | 90 | 3.5 | 190 | 8,736 | A |
| C276 | 100 | 9 | 90 | 18 | 250 | 7,184 | A |
| C276 | 300 | 9 | 90 | 6.5 | 220 | 8,820 | A |
| C276 | 500 | 9 | 90 | 4 | 200 | 9,420 | A |
| C276 | 300 | 7 | 30 | 6 | 220 | 8,567 | A |
| C276 | 500 | 7 | 30 | 4 | 200 | 4,733 | C |

*Mode of coating failure is defined as A: adhesive; C: cohesive; G: glue failure. Secondary failure mode indicated as a percentage of affected surface area.

Slower traverse rates and smaller coating distances typically result in fast material build up rate and result in lower coating adhesion as shown with lowered coating adhesion in Alloy C276 coatings. In the worst case scenarios, Alloy 276 coatings appear to be in danger of spalling off when traverse rates fell near 100″/min. On the other hand, Alloy 1 did not show the adverse effect of traverse rate and/or spray distance, and maintained a relatively constant adhesion strength of >8000 psi with the changing parameters.

Impurity/Oxide Contents Evaluation: In addition to excellent adhesion strength, further analyses showed non-permeable nature of Alloy 1 as compared to the prior art Alloy C276. FIG. 5 are micrographs comparing 25-30 mil thermal spray coatings at 100× made with Alloy 1 (A) and Alloy C276 (B). Dark spots within the thermal spray coatings are indications of either porosity or oxides, both of which are deleterious to alloy performance. As shown, Alloy 1 has much less porosity and oxides than alloy C276. Image analysis software was used to calculate the porosity and oxide content in both coatings. It is common for thermal spray coatings in the prior art to have an impurity concentration (porosity+oxide content) in the range of 20% as with alloy C276. The impurity concentration often further increases as the optimal spray conditions are not maintained, such as a variance in spray angle.

In the experiments, it was found that spraying alloy C276 at decreasing angles results in increased impurity content, up to 35%, whereas Alloy 1 impurity content is relatively stable at below 10% for the wide range of spray angles 30°-90°. The higher degree of spray consistency is uncommon amongst TWAS coatings and highly desirable for reliable performance. Table 3 compares porosity and oxide content in both coatings at different TWAS spray angles as computed using image analysis software:

TABLE 3

| Alloy | Angle | Porosity/Oxides |
|---|---|---|
| Alloy 1 | 30° | 7.3 |
| Alloy 1 | 60° | 9.6 |
| Alloy 1 | 90° | 6.5 |
| Alloy C276 | 30° | 23.5 |
| Alloy C276 | 60° | 27.9 |
| Alloy C276 | 90° | 23.5 |

Image analysis software was further employed in FIG. 6 to show the non-permeable nature of Alloy 1. The micrograph indicates that it is unlikely for the impurities in the coating to form a connected path from the substrate to the surface in Alloy 1 (“A”) thus preventing permeability. This is in sharp contrast to the Alloy C276 micrograph (“B”) with a plurality of connected paths.

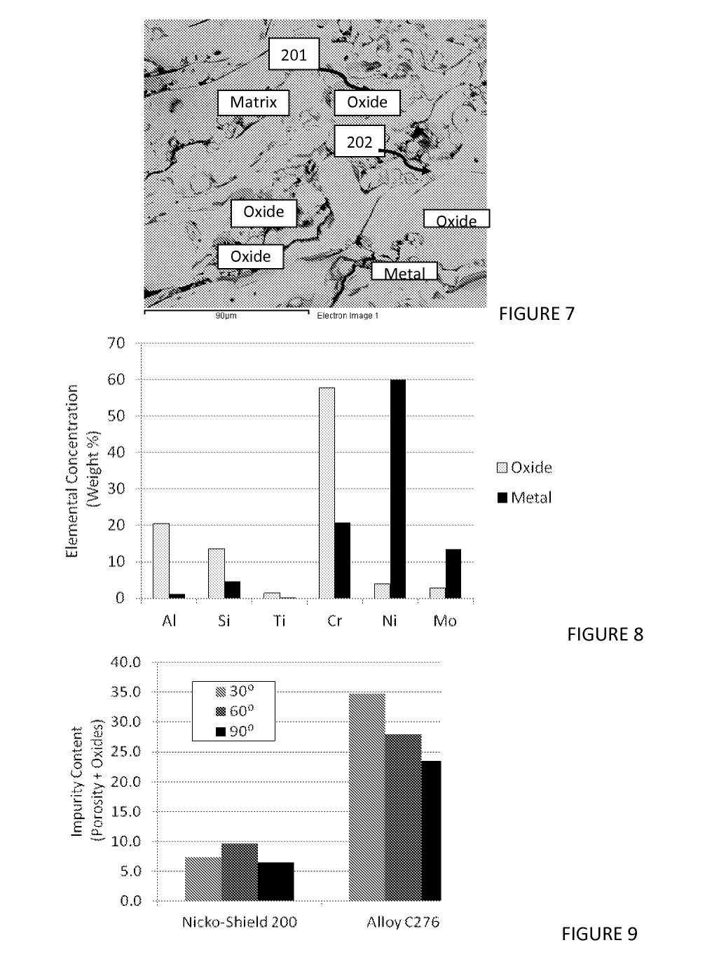

Oxide vs. Metal Contents: In further analyses using energy dispersive spectroscopy (EDS) to study the formation of elemental oxide, it is believed that the reduced embedded oxide content in the final coating structure is the result of the aluminum, titanium, and silicon powder species selectively forming hard oxide particles during the spray process. As shown in the scanning electron micrograph (SEM) of Alloy 1 as in FIG. 7, EDS spectrum acquisition points show the presence of both oxide species (201) and metallic species (202). However, in FIG. 8, it is shown that oxides which are embedded into the coating structure of Alloy 1 contain much higher concentrations of silicon, aluminum, and titanium than the metallic component of the coating.

As shown in FIG. 8, chromium oxide also selectively forms, but the relatively high aluminum content in the oxide chemistry compared to the low aluminum content in the feedstock wire (>20% versus 1.5%) shows that aluminum oxide is preferentially forming during the process. Chromium oxide does make an effective grit blasting component. However, the formation of chromium oxide is generally undesirable due to the depletion of chromium in the metallic component of the coating, which will typically decrease corrosion performance.

Further analysis through SEM shows that the grit blasting components, as indicated by the embedded grit blast particles in Alloy 1 take on the form of oxides of Al, Ti, Si, Cr, and other more complex forms of (Al , Si, Ti, Cr)-rich oxides with particle sizes ranging from 5 to 25 μm. While a portion of the oxides in Alloy 1 do become embedded, the majority are not viscous enough to cling to the thermal spray coating surface and simply bounce of the surface after initial contact. This phenomenon is evident by the reduced oxide content in Alloy 1 (<10%) as compared to Alloy C276 (>20%) despite the use of highly oxidizing elements in Alloy 1. The bombardment with hard oxides that do not attach to the surface is beneficial to the final coating performance in that they cause additional plastic deformation in the metallic species of the coating, thereby roughening the surface, relieving thermal and tensile stresses, increasing bond strength, and decreasing porosity.

FIG. 9 illustrates the reduced deposition efficiency by comparing the thermal spray wire feedstock chemistry of Alloy 1, with the actual composition of the metallic portion of the coating. As shown, the actual amount of metallic Al, Si, and Ti within the coating is reduced from its original chemistry in the wire, with a drop of about 37% for Al and 22% Si, which beneficially results in a slightly increased alloy content of Cr and Mo in the coating and subsequently the overall corrosion resistant rate of the coating.

Corrosion Evaluation: Corrosion measurements were conducted to evaluate the corrosion rate of Alloy 1 coating vs. Alloy C276 coating . The corrosion tests were carried out with coupons coated with Alloy 1 and Alloy C276 in 350° F. (˜180° C.) dilute (83%) H₂SO₄, simulating an environment often experienced in oil refining, chemical processing, among other industries. Bulk Alloy 276 has a reported rate of 200 mpy and low carbon steel has a reported rate of >4000 mpy under these conditions.

The corrosion rate of Alloy 1 remained steady at 80- 90 mpy over two weeks of exposure. Alloy C276 experienced an increased corrosion rate from 90 mpy after Week 1 to 150 mpy after Week 2, a 66% increase. Both coatings saw measureable thickness loss as a result of the exposure, with 4-8 mils for Alloy 1 and 5-8 mils for Alloy C276. The Alloy C276 coating was noticeably smoother after exposure than the exposed Alloy 1 Coupon.

The adhesion of each coating was tested on the exposed area. However, glue adhesion was insufficient to create coating failures in either material. Each surface was lightly blasted with AlO to remove any scale formed during the exposure. The Alloy C276 saw glue failure at around 1,000 psi, likely due to the smoothed contour of the corroded surface. The Alloy 1 coating saw glue failure at 5,000 to 6,000 psi, indicating that it is unlikely that the acid had penetrated the coating thickness to attack the substrate/coating interface directly.

A possible explanation for the ability of the Alloy 1 coating to maintain a stabilized corrosion rate and a high level of coating adhesion after corrosive exposure is the ‘scale clogging’ effect. Reducing oxide concentration is a factor in reducing permeability in corrosive conditions, and allows a coating containing some level of porosity (such as a thermal spray coating) to form a completely impermeable surface. Corrosive conditions such as sulfuric acid lead to the formation of protective oxides on the surfaces of metallic particles within the coating structure. This scale prevents further corrosion on the surface, but also serves to clog porosity in the coating structure and prevent further ingress of corrosion species. Oxides embedded during the spray process may or may not be susceptible to corrosion themselves, but cannot effectively generate scale. Thus, corrosive media can more easily travel between oxide boundaries than between metal boundaries due to the ‘scale clogging’ effect.

Visual Observations: Experiments were repeated using the twin wire arc spray process using different brands of equipment under non-ideal conditions confirmed that Alloy 1 consistently has high coating integrity compared to Alloy C276 (where this difference can be seen with the naked eye).

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

The written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A work piece having a coating on at least a surface, the work piece comprising
a metal surface onto which a coating is applied by thermal spraying a wire comprising a NiCrMoX alloy, wherein X contains at least two gettering elements selected from Al, Si, Ti in an amount of 5-20 wt. %;
wherein the coating has as an impurity content of less than 15%, a corrosion rate of less than 150 mpy measured according to ASTM G31, and an adhesion strength of at least 9,000 psi measured according to ASTM D4541.

2. The work piece of claim 1, wherein the work piece is repaired by applying the coating onto the metal surface.

3. The work piece of claim 1, wherein the work piece is selected from the group of recovery boilers, furnace tubes, metal sheets, panels, pressure vessels, separator vessels, drums, rail cars, heat exchangers, pipes, heat exchanger parts, storage tanks, valves, chamber enclosure wall, substrate support, gas delivery system and components, and gas exhaust system and components.

4. The work piece of claim 1, wherein the coating has a thickness of 2- 100 mils.

5. The work piece of claim 1, wherein the coating has an impurity content of less than 10%.

6. The work piece of claim 1, wherein the coating has an adhesion strength of at least 10,000 psi measured according to ASTM D4541.

7. The work piece of claim 1, wherein the coating has a corrosion rate of less than 125 mpy measured according to ASTM G31.

8. The work piece of claim 1, wherein the coating has a corrosion rate of less than 100 mpy measured according to ASTM G31.

9. The work piece of claim 1, wherein the coating is applied onto the metal surface by any of sprayed flame, wire, plasma, and high velocity oxy fuel (HVOF) thermal spraying technique.

10. The work piece of claim 1, wherein the coating is applied onto the metal surface by twin wire arc spray (TWAS) technique.

11. The work piece of claim 1, wherein the coating is applied onto the metal surface manually with thermal spraying parameters of: a spray angle variation of +60° from 90°; a traverse rate variation of ±600 inches/min; and a spray distance variation of up to 9″.

12. The work piece of claim 1, wherein the coating has an adhesion strength variation of less than 25%.

13. The work piece of claim 1, wherein the wire contains in weight percent: 12-25% Cr; 8-15% Mo; X contains at least two gettering elements selected from Al, Si, and Ti in an amount of up to 12% each with a total concentration of 5-25%; balance of Ni and unavoidable impurities.

14. The work piece of claim 13, wherein the two gettering elements selected from Al, Si, and Ti are in an amount of up to 10% each with a total concentration between 10-20%.

15. The work piece of claim 1, wherein the wire is cored wire, formed with a sheet having the alloy composition of NiCr rolled into a tubular form containing X as a powder contained within the tubular form as the core, wherein X contains Mo, Al and at least one of two gettering elements Si and Ti.

16. A work piece having a coating on at least a surface, the work piece comprising
a metal surface onto which a coating is applied by thermal spraying a wire feedstock comprising a nickel alloy in weight %: Cr: 12%-25%; Mo: 8%-15%; and at least two gettering elements selected from Al: 0.25-12%, Si: up to 10%, and Ti: up to 5%; balance of Ni and unavoidable impurities;
wherein the coating has an impurity content of less than 15% , a corrosion rate of less than 150 mpy measured according to ASTM G31, and an adhesion strength of at least 9,000 psi measured according to ASTM D4541.

17. The work piece of claim 16, the coating has an impurity content of less than 10% , a corrosion rate of less than 100 mpy measured according to ASTM G31, and an adhesion strength of at least 10,000 psi measured according to ASTM D4541.

18. A work piece having a coating on at least a surface, the work piece comprising
a metal surface onto which a coating is applied by thermal spraying a wire comprising a NiCrMoX alloy, wherein X contains at least two gettering elements selected from Al, Si, Ti; and X is present in a sufficient amount to form hard oxide particles which do not adhere to the surface of the equipment and function to grit blast the surface for the coating to have an adhesion strength of at least 9,000 psi measured according to ASTM D4541.

19. The work piece of claim 18, wherein the coating is applied by twin wire arc spray (TWAS) technique manually with spraying parameters including a spray angle variation of +60° from 90°; a traverse rate variation of ±600 inches/min; and a spray distance variation of up to 9″.

20. The work piece of claim 19, wherein the coating has an adhesion strength variation of less than 25%.

21. The work piece of claim 18, wherein the coating is applied to repair at least a portion of the metal surface on the work piece.
